(19) United States
(12) Patent Application Publication
(10) Pub. No.: US 2026/0063300 A1
(43) Pub. Date: Mar. 5, 2026

(54) BURNER FOR COMBUSTOR WITH HYDROGEN GENERATION FROM AMMONIA AND RELATED METHOD

(71) Applicant: GE Vernova Infrastructure Technology LLC, Greenville, SC (US)

(72) Inventor: Rajani Kumar Akula, Bangalore (IN)

(21) Appl. No.: 19/256,509

(22) Filed: Jul. 1, 2025

(30) Foreign Application Priority Data
Aug. 30, 2024 (IN) 202411065747

(51) Int. Cl. F23R 3/42; C01B 3/04; F23D 14/02; F23R 3/00; F23R 3/14; F23R 3/28

(52) U.S. Cl. CPC F23R 3/42; C01B 3/047; F23D 14/02; F23R 3/005; F23R 3/14; F23R 3/286

(57) ABSTRACT

A burner for a combustor of a gas turbine system is disclosed. The burner includes an outer fuel/air premixer body that mixes fuel and air for injection into a combustion chamber. An inner hydrogen-generating body is within the outer fuel/air premixer body. The hydrogen-generating body includes a hollow body having a second air inlet, and an ammonia passage within the hollow body. The ammonia passage has an ammonia inlet, a heat exchanger portion, a catalyst portion downstream, and an exit to the combustion chamber. An air flow from the second air inlet in the hollow body heats the heat exchanger portion and the catalyst portion to generate a hydrogen-containing flow from an ammonia flow therein. The hydrogen exits the ammonia passage to the combustor reaction zone to stabilize combustion with ammonia and the fuel/air mixture from the outer fuel/air premixer body. A related method is also disclosed.

### TECHNICAL FIELD

The disclosure relates generally to turbomachine combustors and, more specifically, to a burner that generates hydrogen from ammonia, a combustor including the burner and a related method.

### BACKGROUND

Gas turbine systems include a combustion section including a plurality of combustors in which fuel is combusted to create a flow of combustion gas that is converted to kinetic energy in a downstream turbine section. Current combustors include a head end fuel nozzle assembly including a plurality of burners for combusting fuel in a (primary) combustion zone. Axial fuel stage (AFS) injectors may be used for combusting fuel in another (secondary) combustion zone downstream of the primary combustion zone. Portions of an air supply from, for example, a compressor discharge, are delivered to the head end fuel nozzle assembly and the AFS injectors in various flow passages.

One of the issues with conventional combustors is that the combustion of hydrocarbons (e.g., natural gas) commonly results in the formation of carbon dioxide (CO₂) and nitrogen oxides (NOx), which are costly to mitigate. To reduce the amount of CO₂ produced, some manufacturers have sought to use alternate fuel sources, including hydrogen and ammonia, which remove carbon from the combustion products. Current combustors present challenges relative to using ammonia as a fuel. In particular, ammonia suffers from low flammability and has a low heating value and may not stabilize very well causing at least part of the combustion reaction to extinguish.

### BRIEF DESCRIPTION

All aspects, examples, and features mentioned below can be combined in any technically possible way.

An aspect of the disclosure includes a burner for a combustor of a gas turbine system, the burner comprising: an outer fuel/air premixer body having a first air inlet, a fuel inlet, and a mixing passage, the outer fuel/air premixer body mixing fuel and air for injection into a combustion chamber; and an inner hydrogen-generating body within the outer fuel/air premixer body, the inner hydrogen-generating body including: a hollow body having a second air inlet; and an ammonia passage within the hollow body, the ammonia passage having an ammonia inlet, a heat exchanger portion downstream from the ammonia inlet, a catalyst portion downstream of the heat exchanger portion, and an exit to the combustor reaction zone downstream of the catalyst portion, wherein an air flow from the second air inlet in the hollow body heats the heat exchanger portion and the catalyst portion to generate a hydrogen-containing flow from an ammonia flow therein, the hydrogen-containing flow exiting from the exit of the ammonia passage to the combustion chamber.

Another aspect of the disclosure includes any of the preceding aspects, and the heat exchanger portion includes one of a helical passage and a sinusoidal passage.

Another aspect of the disclosure includes any of the preceding aspects, and the first air inlet and the second air inlet are in fluid communication with a discharge of a compressor upstream of the burner, wherein air entering the second air inlet has a higher temperature than the ammonia flow in the heat exchanger portion.

Another aspect of the disclosure includes any of the preceding aspects, and the ammonia flow is gaseous ammonia.

Another aspect of the disclosure includes any of the preceding aspects, and the outer fuel/air premixer body includes a first tube concentrically spaced from a second tube, and a swozzle assembly between the first tube and the second tube downstream of the first air inlet, the swozzle assembly including a plurality of turning vanes imparting a swirl to air passing therebetween, wherein each of the turning vanes includes an internal fuel flow passage in fluid communication with at least one fuel nozzle, the fuel inlet introducing fuel into the internal fuel flow passage.

Another aspect of the disclosure includes any of the preceding aspects, and further comprising an end plate coupled to the inner hydrogen-generating body, the end plate configured to removably position the inner hydrogen-generating body within the outer fuel/air premixer body.

Another aspect of the disclosure includes any of the preceding aspects, and the second air inlet includes an opening in the end plate in fluid communication with a source of hot air.

Another aspect of the disclosure includes any of the preceding aspects, and the second air inlet includes an opening in the hollow body in fluid communication with the mixing passage.

Another aspect of the disclosure includes any of the preceding aspects, and the catalyst portion is replaceable.

Another aspect of the disclosure includes any of the preceding aspects, and further comprising a first passage support positioned upstream of the catalyst portion to position the ammonia passage within the hollow body, and a second passage support positioned downstream of the catalyst portion to position the ammonia passage within the hollow body, wherein each passage support includes an open interior to allow air to pass therethrough

Another aspect of the disclosure includes a combustor for a gas turbine system, the combustor comprising: a combustor body including a combustion liner; a head end assembly including a plurality of burners directed into the combustion liner, at least one burner including: an outer fuel/air premixer body having a first air inlet, a fuel inlet, and a mixing passage, the outer fuel/air premixer body mixing fuel and air for injection into a combustion chamber; and an inner hydrogen-generating body within the outer fuel/air premixer body, the inner hydrogen-generating body including: a hollow body having a second air inlet; and an ammonia passage within the hollow body, the ammonia passage having an ammonia inlet, a heat exchanger portion downstream from the ammonia inlet, a catalyst portion downstream of the heat exchanger portion, and an exit to the combustor reaction zone downstream of the catalyst portion, wherein an air flow from the second air inlet in the hollow body heats the heat exchanger portion and the catalyst portion to generate a hydrogen-containing flow from an ammonia flow therein, the hydrogen-containing flow exiting from the exit of the ammonia passage to the combustion chamber.

Another aspect of the disclosure includes any of the preceding aspects, and the heat exchanger portion includes one of a helical passage and a sinusoidal passage.

Another aspect of the disclosure includes any of the preceding aspects, and the first air inlet and the second air inlet are in fluid communication with a discharge of a compressor upstream of the burner, wherein air entering the second air inlet has a higher temperature than the ammonia flow in the heat exchanger portion.

Another aspect of the disclosure includes any of the preceding aspects, and the outer fuel/air premixer body includes a first tube concentrically spaced from a second tube, and a swozzle assembly between the first tube and the second tube downstream of the first air inlet, the swozzle assembly including a plurality of turning vanes imparting a swirl to air passing therebetween, wherein each of the turning vanes includes an internal fuel flow passage in fluid communication with at least one fuel nozzle, the fuel inlet introducing fuel into the internal fuel flow passage.

Another aspect of the disclosure includes any of the preceding aspects, and further comprising an end plate coupled to the inner hydrogen-generating body, the end plate configured to removably position the inner hydrogen-generating body within the outer fuel/air premixer body.

Another aspect of the disclosure includes any of the preceding aspects, and the second air inlet includes an opening in the end plate in fluid communication with a source of hot air.

Another aspect of the disclosure includes any of the preceding aspects, and the second air inlet includes an opening in the hollow body in fluid communication with the mixing passage.

Another aspect of the disclosure includes any of the preceding aspects, and further comprising a first passage support positioned upstream of the catalyst portion to position the ammonia passage within the hollow body, and a second passage support positioned downstream of the catalyst portion to position the ammonia passage within the hollow body, wherein each passage support includes an open interior to allow air to pass therethrough.

Another aspect of the disclosure includes a method comprising: in a burner for a combustor of a gas turbine system: mixing air and fuel for injection into a combustion chamber of the combustor in an outer fuel/air premixer body having a first air inlet, a fuel inlet and an mixing passage; and generating hydrogen for injection into the combustor reaction zone in an inner hydrogen-generating body inside the mixing passage of the outer fuel/air premixer body, the hydrogen generating including heating a gaseous ammonia in an ammonia passage in the hydrogen-generating body to form a hydrogen-containing flow; and injecting the hydrogen-containing flow into the combustion chamber for combustion with a fuel/air mixture from the outer fuel/air premixer body.

Another aspect of the disclosure includes any of the preceding aspects, and an inner hydrogen-generating body includes: a hollow body having a second air inlet; and wherein the ammonia passage is within the hollow body and includes an ammonia inlet, a heat exchanger portion downstream from the ammonia inlet, a catalyst portion downstream of the heat exchanger portion, and an exit to the combustion zone downstream of the catalyst portion, wherein the heating includes directing an air flow from the second air inlet in the hollow body over the heat exchanger portion and the catalyst portion to generate the hydrogen from a gaseous ammonia flow therein, the hydrogen-containing flow exiting from the exit of the ammonia passage for the injecting into the combustion chamber.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects, and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a functional block diagram of an illustrative gas turbine system capable of use with a combustor including a burner, according to embodiments of the disclosure;

FIG. 2 shows a cross-sectional side view of a combustor including a burner, according to embodiments of the disclosure;

FIG. 3 shows a partially cross-sectional perspective view of a burner for a combustor, according to embodiments of the disclosure;

FIG. 4 shows a cross-sectional view of a burner for a combustor, according to embodiments of the disclosure;

FIG. 5 shows a cross-sectional view of a burner for a combustor, according to other embodiments of the disclosure;

FIG. 6 shows a cross-sectional view of an inner hydrogen-generating body removed from a burner for a combustor, according to embodiments of the disclosure; and

FIG. 7 shows a perspective view of a passage support for an ammonia passage of an inner hydrogen-generating body for a burner, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a turbomachine combustor and related burner therefor. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through a combustor of the turbomachine or, for example, the flow of air or ammonia through the combustor or burner, or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine or combustor, and “aft” referring to the rearward or turbine end of the turbomachine or combustor.

The term “axial” refers to movement or position parallel to an axis, e.g., an axis of a combustor, a mixing chamber of the AFS injector, or turbomachine. The term “radial” refers to movement or position perpendicular to an axis, e.g., an axis of a combustor or a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a combustor body or a circumferential interior of casing extending about a combustor. As indicated above, and depending on context, it will be appreciated that such terms may be applied in relation to the axis of the combustor, burner or the turbine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs, or the feature is present and instances where the event does not occur, or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure provides a burner for a combustor of a gas turbine system, a combustor, and a related method. The burner includes an outer fuel/air premixer body that mixes fuel and air for injection into a combustor reaction zone in a combustor body. An inner hydrogen-generating body is disposed within the outer fuel/air premixer body. The hydrogen-generating body includes a hollow body having a second air inlet and an ammonia passage within the hollow body. The ammonia passage has an ammonia inlet, a heat exchanger portion, a catalyst portion downstream of the heat exchanger portion, and an exit to the combustor reaction zone. An air flow from the second air inlet in the hollow body heats the heat exchanger portion and the catalyst portion to generate a hydrogen-containing flow from an ammonia flow, e.g., gaseous ammonia, therein. The hydrogen-containing flow exits the ammonia passage to the combustor reaction zone.

The hydrogen-generating body presents an efficient way of providing hydrogen (H₂) for combustion using ammonia cracking. The hydrogen-generating body may provide complete conversion of ammonia (NH₃) to hydrogen (H₂) and nitrogen (N₂), or partial conversion of ammonia to hydrogen (H₂) and nitrogen (N₂) and ammonia (NH₃). In any event, the hydrogen-generating body generates the minimum requirement of hydrogen in the hydrogen-containing flow such that it is between 0.5% to 1% of total fuel flow. The resulting hydrogen-containing flow with air is injected in a center of each burner, i.e., like a pilot fuel injection. The hydrogen-containing flow enhances the overall stabilization of the combustion by allowing burning of ammonia with the fuel/air mixture from the outer fuel/air premixer body and using the hydrogen to stabilize the combustion.

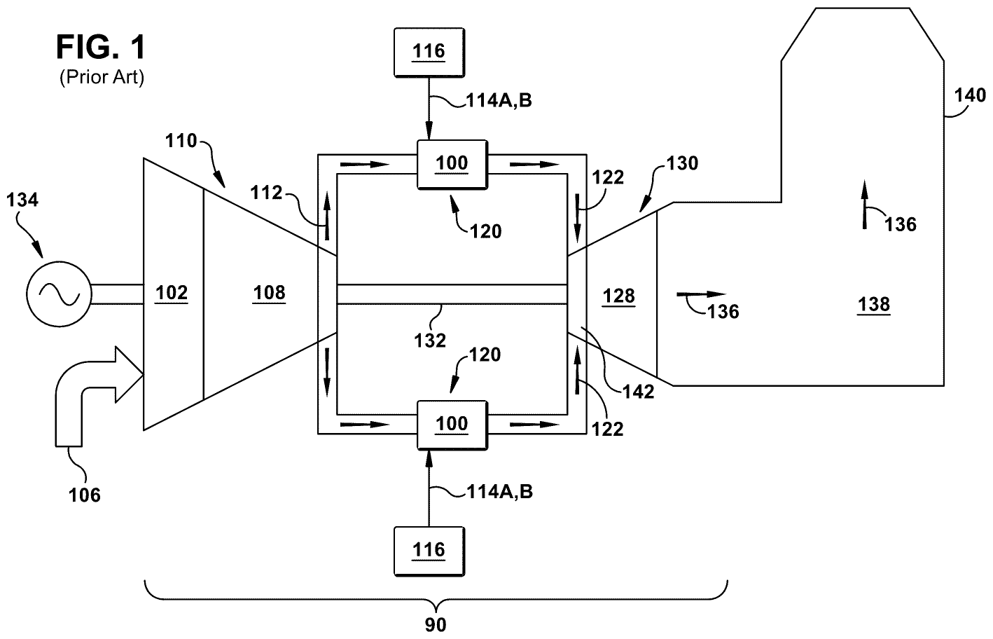

FIG. 1 shows a functional block diagram of an illustrative gas turbine (GT) system 90 that may incorporate various embodiments of a combustor 100 and a burner 200 of the present disclosure. As shown, GT system 90 generally includes an inlet section 102 that may include a series of filters, cooling coils, moisture separators, and/or other devices to purify and otherwise condition air 106 entering GT system 90. Air 106 flows to a compressor 108 in a compressor section 110 that progressively imparts kinetic energy to air 106 to produce a compressed, high-pressure (HP) air 112 (hereafter “HP air 112” or “compressed air 112”) at a highly energized state. HP air 112 is typically mixed with one or more fuels, e.g., fuels 114A and/or 114B, from a fuel source(s) 116 to form a combustible mixture within at least one combustor 100 in a combustion section 120 that is operatively coupled to compressor section 110. The combustible mixture is burned to produce combustion gases 122 having a high temperature and pressure. Combustion gases 122 flow through a turbine 128 (i.e., an expansion turbine) of a turbine section 130 operatively coupled to combustion section 120 to produce work. For example, turbine 128 may be connected to a shaft 132 so that rotation of turbine 128 drives compressor 108 to produce HP air 112. Alternatively, or in addition, shaft 132 may connect turbine 128 to another load, such as a generator 134 for producing electricity. Exhaust gases 136 from turbine 128 flow through an exhaust section 138 that connects turbine 128 to an exhaust stack 140 downstream from turbine 128. Exhaust section 138 may include, for example, a heat recovery steam generator (not shown) for cleaning and extracting additional heat from exhaust gases 136 prior to release to the environment. Where more than one combustor 100 is used, they may be circumferentially spaced around a turbine inlet 142 of turbine 128.

In one embodiment, GT system 90 may include a current engine model commercially available from GE Vernova of Cambridge, MA. The present disclosure is not limited to any one particular GT system and may be implanted in connection with other engines including, for example, any HA, F, B, LM, GT, TM and E-class engine models of GE Vernova, and engine models of other companies. Furthermore, the present disclosure is not limited to any particular turbomachine, and may be applicable to, for example, steam turbines, jet engines, compressors, turbofans, etc.

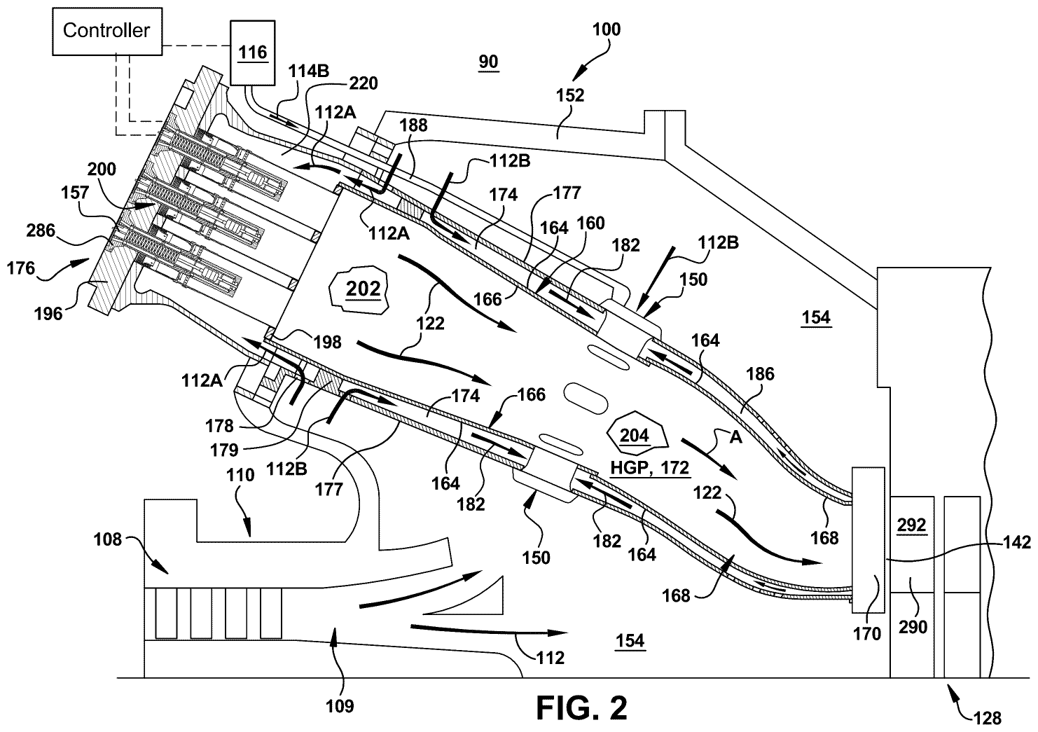

An illustrative combustor 100 usable within GT system 90 will now be described. FIG. 2 shows a cross-sectional side view of combustor 100 positioned within GT system 90. As will be further described herein, combustor 100 may include a plurality of burners 200 according to embodiments of the disclosure. While an illustrative combustor 100 will be described herein, it is emphasized that burner(s) 200 according to embodiments of the disclosure may be used in a large variety of different types of combustors 100. Hence, the teachings of the disclosure are not limited to any particular combustor.

As shown in FIG. 2, combustor 100 is at least partially surrounded by an outer casing 152 such as a compressor discharge casing and/or a turbine casing. An interior of outer casing 152 is in fluid communication with a compressor discharge 109 of compressor 108 and creates an HP air source 154. That is, HP air source 154 includes HP air 112 from compressor discharge 109 of compressor 108. HP air source 154 is in direct fluid communication with a compressor discharge 109 of GT system 90. However, HP air source 154 may be any supply of HP air 112 capable of flowing into any variety of opening or flow passage in combustor 100 to cool parts and/or for combustion, i.e., using burners 200 or axial fuel stage (AFS) injectors 150.

As shown in FIG. 2, combustor 100 for GT system 90 includes a combustor body 160. Combustor body 160 may be made using any now known or later developed techniques. For example, combustor body 160 may be additively manufactured. Combustor body 160 may include a combustion liner 164, which may include, for example, a cylindrical portion 166 and a tapered transition portion 168. Combustion liner 164 may have an axis A, the direction of which may vary slightly depending on axial location within the curved combustion liner 164. Tapered transition portion 168 is at an aft end (right side as shown in FIG. 2) of cylindrical portion 166. As understood in the field, tapered transition portion 168 transitions the hot gas path (HGP) from the circular cross-section of the liner's cylindrical portion 166 to a more arcuate cross-section for mating with turbine inlet 142 of turbine 128. Combustor 100 may also include an aft frame 170 at an aft end (right side in FIG. 2) of tapered transition portion 168.

Combustion liner 164 may contain and convey combustion gases 122 to turbine section 130 (FIG. 1). More particularly, combustion liner 164 defines a combustion chamber 172, i.e., in a hot gas path (HGP), within which combustion occurs. Combustion liner 164 may have tapered transition portion 168 that is separate from cylindrical portion 166, as in many conventional combustion systems. Alternatively, combustion liner 164 may have a unified body (or “unibody”) construction, in which cylindrical portion 166 and tapered transition portion 168 are integrated with one another, i.e., as part of an additively manufactured one-piece member. Thus, any discussion of combustion liner 164 herein is intended to encompass both conventional combustion systems having a separate cylindrical and tapered transition portions and those combustion systems having a unibody liner.

Combustor body 160 also includes an air flow passage 174 defined at least partially by cylindrical portion 166 of combustion liner 164. As will be described herein, air flow passage 174 is configured to deliver air (e.g., HP air 112A from HP air source 154) to a head end assembly 176 of combustor 100 at a forward end (left end in FIG. 2) of combustion liner 164. That is, it is sized, shaped, and/or arranged to deliver air, such as HP air 112A from HP air source 154, to head end assembly 176 of combustor 100, i.e., a high-pressure plenum 220 of head end assembly 176. Air flow passage 174 may be defined between cylindrical portion 166 and a flow sleeve 177 spaced along at least a portion of an exterior surface of cylindrical portion 166. Air flow passage 174 has an open end 178, or air flow opening(s), proximate to head end assembly 176 through which HP air 112A from HP air source 154 enters.

An annular partition 179 disposed between cylindrical portion 166 and flow sleeve 177 separates a forward portion of air flow passage 174 from an aft portion of air flow passage 174. The axial position of annular partition 179 is approximately aligned with a cap assembly 198, discussed below, such that the forward portion of air flow passage 174 is radially outward of head end assembly 176 (rather than combustion chamber 172) and, therefore, requires less cooling. Aftward of annular partition 179, flow sleeve 177 may include a plurality of impingement holes 192 (as shown in outer sleeve 190), which permit HP air 112B to flow into air flow passage 174. As a result of passing through impingement holes 192, HP air 112B experiences a pressure drop and becomes LP air 182, which flows through air flow passage 174 toward and/or into AFS injector(s) 150, as discussed further herein.

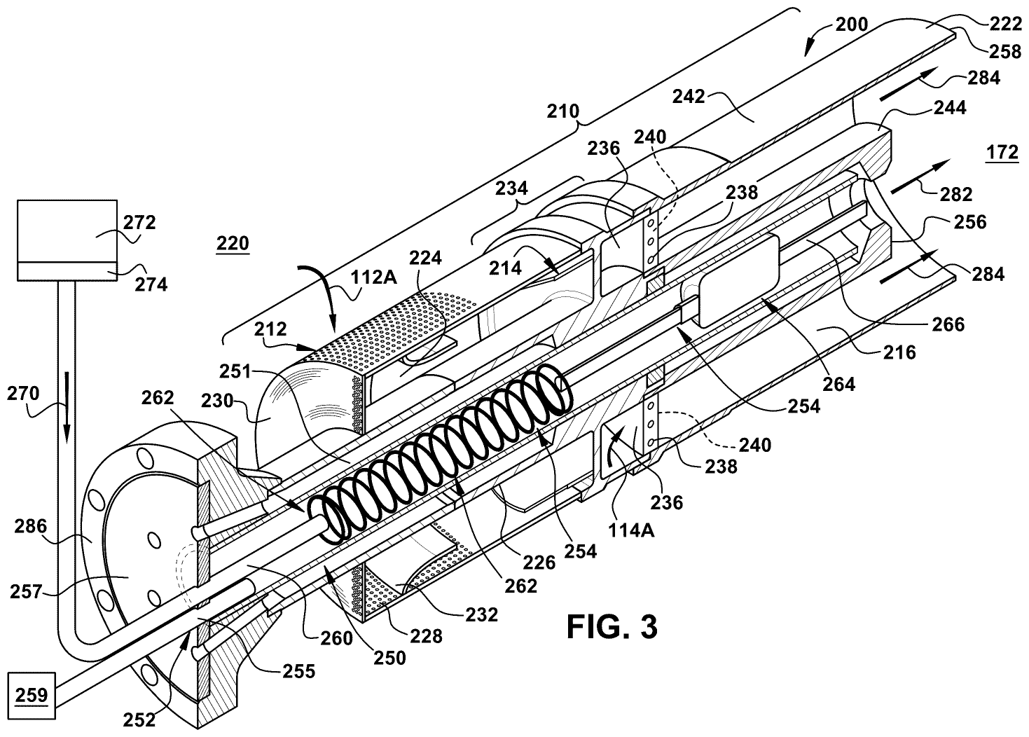

Head end assembly 176 generally includes at least one axially extending fuel nozzle or burner 200 (hereafter “burner 200”). Burners 200, as will be described further herein, direct fuel and air into a combustion chamber 172 of combustor 100. Combustor chamber 172 may include a primary combustion zone 202 in a forward portion of combustion liner 164. In certain embodiments, although not shown, axially extending burner(s) 200 of head end assembly 176 may extend at least partially through end cap assembly 198 to provide a combustible mixture of fuel 114A (FIGS. 3-5) and HP air 112A to a primary combustion zone 202 of combustion reaction zone 201 in combustion liner 164.

Combustor body 160 also optionally includes one or more axial fuel stage (AFS) injectors 150 directed into combustion liner 164 downstream of head end assembly 176. Each AFS injector 150 receives HP air 112B from HP air source 154, among possibly other air flows, and fuel 114B from fuel source 116. AFS injector(s) 150, when provided, combust fuel 114B and HP air 112B in a secondary combustion zone 204 of combustion chamber 172 in combustion liner 164. Fuel 114B may be delivered from fuel source 116 using any form of fuel line(s) 188. As illustrated, combustor 100 and combustor body 160 may include a plurality of circumferentially spaced AFS injectors 150. Any number of AFS injectors 150 can be used. That is, AFS injector 150 may include a plurality of AFS injectors 150 circumferentially spaced around combustor body 160. Each AFS injector 150 extends radially through combustion liner 164 downstream from head end assembly 176, which includes axially extending burners 200, as introduced above and as further discussed herein. While AFS injectors 150 are shown at one axial location of combustor body 160, sets of AFS injectors 150 may be provided at different axial locations of combustion liner 164, e.g., downstream of AFS injectors 150 (as shown in FIG. 2) and upstream of aft frame 170.

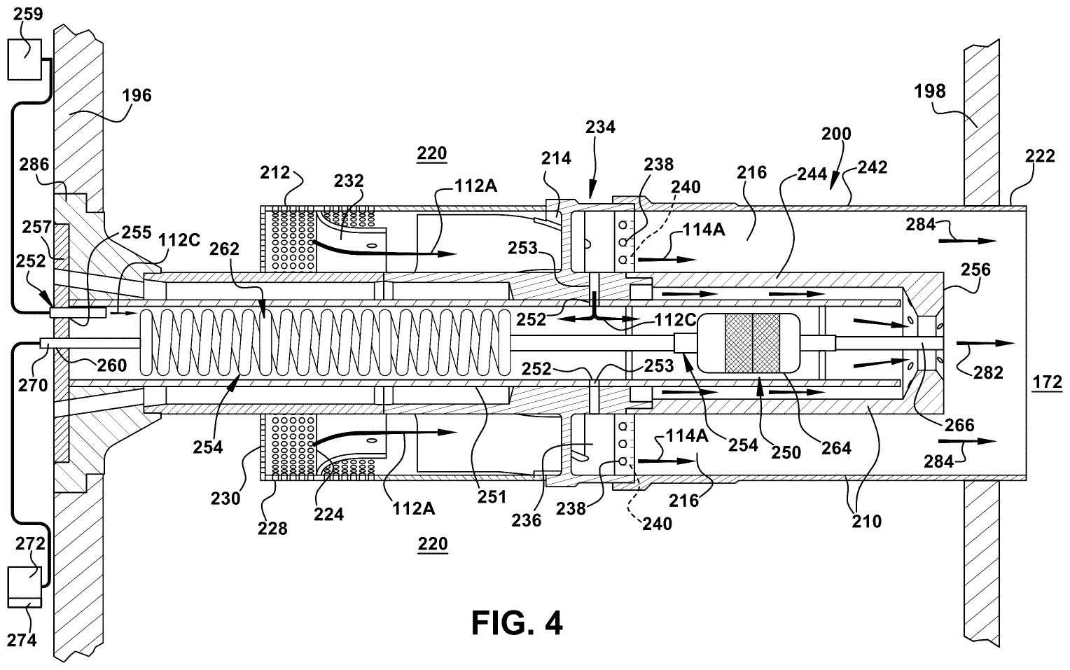

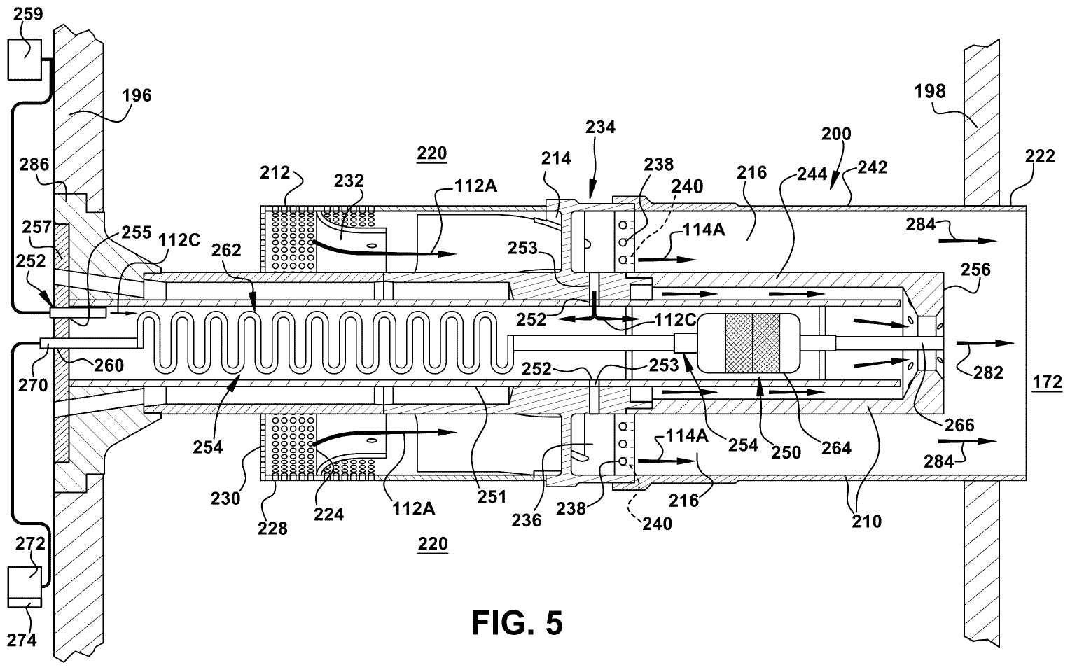

FIG. 3 shows a partially cross-sectional perspective view, and FIG. 4 shows a cross-sectional view of burner 200 for combustor 100 of GT system 90, according to embodiments of the disclosure. FIG. 5 shows a cross-sectional view of burner 200 for combustor 100 of GT system 90, according to other embodiments of the disclosure.

As shown in FIGS. 3 and 4, burner 200 includes an outer fuel/air premixer body 210 (hereafter “outer premixer body 210”) having a first air inlet 212, a fuel inlet 214 and a mixing passage 216. Outer premixer body 210 mixes fuel 114A and air, e.g., HP air 112A, for injection into combustion chamber 172. Air 112A enters burner 200 from a high-pressure plenum 220 in head end assembly 176 (FIG. 2), which surrounds burner 200 except at a discharge end 222 thereof, which is aimed into and may extend partially into combustion chamber 172. Air 112A enters high-pressure plenum 220 from HP air source 154 as previously described. Air 112A for combustion enters outer premixer body 210 via first air inlet 212. First air inlet 212 may include any opening(s) allowing air flow into burner 200. For purposes of illustration, first air inlet 212 is illustrated as an inlet flow conditioner (IFC) including an annular flow passage 224 that is bounded by a solid cylindrical inner wall 226 at the inside diameter, a perforated cylindrical outer wall 228 at the outside diameter, and a perforated end cap 230 at the upstream end. In the center of flow passage 224, one or more annular turning vanes 232 may be optionally provided. Air 112A for outer premixer body 210 enters the IFC via the perforations in end cap 230 and cylindrical outer wall 228. As noted, other forms of air inlets are also possible.

In certain embodiments, outer premixer body 210 may include a first (outer) tube 242 concentrically spaced from a second (inner) tube 244. Outer premixer body 210 may also include a swozzle assembly 234 extending radially between first tube 242 and second tube 244 and positioned axially downstream of first air inlet 212. Mixing passage 216 extends through swozzle assembly 234 (i.e., between vanes of the swozzle assembly 234) and may be annular between first tube 242 and second tube 244 outside of swozzle assembly 234. Second tube 244 provides solid cylindrical inner wall 226 at the inside diameter of the IFC.

Swozzle assembly 234 includes a plurality of turning vanes 236 imparting a swirl to air 112A flowing therebetween. Each of turning vanes 236 may also include an internal fuel flow passage 238 in fluid communication with at least one fuel injector 240. Fuel inlet 214 introduces fuel 114A into the internal fuel flow passage 238. After air 112A exits the IFC, it enters swozzle assembly 234. Each turning vane 236 includes various fuel 114A supply passages (not shown) therein to distribute fuel 114A, e.g., natural gas, to one or more sets of fuel injectors 240, which penetrate the wall of the aerodynamically shaped turning vane 236. Fuel injectors 240 may be located on the pressure side, the suction side, or both sides of turning vanes 236. Fuel 114A begins mixing with air 112A in swozzle assembly 234, and fuel/air mixing is completed in mixing passage 216, which as noted may be formed between an inside of first outer tube 242 and an outside of second inner tube 244. Second inner tube 244 may also be alternatively referenced as a swozzle hub extension, and first outer tube 242 may also be alternatively referenced as a swozzle shroud extension. After exiting mixing passage 216, fuel/air mixture 284 enters combustion chamber 172 and ignites in primary combustion zone 202 where combustion takes place. As understood in the art, swozzle assembly 234 injects fuel 114A through the surface of aerodynamic turning vanes (airfoils) 236 so the disturbance to the air flow field is minimized. While a particular outer fuel/air premixing body 210 has been described herein, it is emphasized that various other structures may be used to provide fuel/air mixture 284 and are considered within the scope of the disclosure.

With continuing reference to FIGS. 3 and 4, burner 200 also includes an inner hydrogen-generating body 250 within outer premixer body 210. Inner hydrogen-generating body 250 (hereafter “inner body 250”) includes a hollow body 251 having a second air inlet 252, and an ammonia passage 254 within hollow body 251. In certain embodiments, second air inlet 252 may include an opening 253 in hollow body 251 in fluid communication with mixing passage 216, e.g., directly to passage 216 or to passage 216 via swozzle assembly 234. Alternatively, or in addition thereto, second air inlet 252 may include an opening 255 in an end plate 257 in fluid communication with a source of hot air 259. Source of hot air 259 can be any source of air 112C having a temperature sufficient to crack ammonia in ammonia passage 254, e.g., turbine 128 discharge cooling air, compressor discharge air 112C. While both forms of second air inlet 252 are shown, only one form may be used. In certain embodiments, first air inlet 212 and second air inlet 252 (regardless of form) may be in fluid communication with compressor discharge 109 of compressor 108 upstream of burner 200, e.g., via high pressure plenum 220 in head end assembly 176 (FIG. 2), HP air source 154 or other fluid connection. Ammonia passage 254 includes an ammonia inlet 260, a heat exchanger portion 262 downstream from ammonia inlet 260, a catalyst portion 264 downstream of heat exchanger portion 262, and an exit 266 to combustion chamber 172 downstream of catalyst portion 264.

As shown in FIG. 3, ammonia 270 (see arrow) may be directed to ammonia inlet 260 from an ammonia source 272. Ammonia 270 may be another form of fuel, e.g., a fuel 114B, and ammonia source 272 may be another form of fuel source 116, as described previously. In certain embodiments, ammonia 270 may be in liquid form; however, this is not preferred as the temperature must remain relatively low to maintain liquid form, e.g., less than approximately-33° C. (−28° F.). In other embodiments, flow of ammonia 270 may be in gaseous form, or mostly gaseous form. If necessary, ammonia source 272 may include a heater 274 to increase conversion of ammonia 270 to a gaseous form. Heater 274 may take any appropriate form for heating ammonia 270 into a gaseous form.

Ammonia passage 254 may include any conduit, e.g., pipe or tubular element, capable of carrying ammonia in liquid or gaseous form therein. Heat exchanger portion 262 may include a variety of different shapes therein to increase an area thereof to increase heat exchange between air 112C and ammonia 270. FIGS. 3 and 4 show heat exchanger portion 262 having a helical passage. In this case, heat exchanger portion 262 may include any number of helical coils with any overall diameter within hollow body 251. In another embodiment, shown in FIG. 5, heat exchanger portion 262 includes a sinusoidal passage. In this case, heat exchanger portion 262 may include any number of peak/valleys and any overall diameter within hollow body 251. Combinations of helical, sinusoidal, or other path(s) that increases surface area of ammonia passage 254 to create heat exchanger portion 262 can also be used.

Catalyst portion 264 may include any now known or later developed structure allowing ammonia 270 to contact a catalyst material therein that is capable of cracking at least part of ammonia 270, i.e., NH₃, into constituent elements hydrogen (H₂) and nitrogen (N₂). “Cracking,” as used herein relative to ammonia 270, means decomposing, breaking apart, converting and/or separating ammonia NH₃ into its constituent elements hydrogen (H₂) and nitrogen (N₂). Catalyst portion 264 may include a material including but not limited to: anodized aluminum (Al); carbon nanotube supported ruthenium (Ru CNT); Ru CNT with potassium hydroxide (KOH); ruthenium (Ru) and cesium (Cs); ruthenium (Ru) and aluminum oxide (Al₂O₃); nickel (Ni) and aluminum oxide (Al₂O₃); nickel-cerium oxide (Ni—CeO₂) and aluminum oxide (Al₂O₃); nickel (Ni) and mesoporous silica; sodium (Na) and sodium amide (NaNH₂). It will be understood that a wide variety of other ammonia cracking materials are also possible. The heat transfer from air 112C to ammonia 270 in heat exchanger portion 262 and catalyst portion 264 is sufficient to achieve cracking by catalyst portion 264. Catalyst portion 264 does not need to crack all of ammonia 270 because the hydrogen content requirement may only need to be between 0.5% to 1% of total fuel flow to achieve the desired combustion stabilization while combusting ammonia 270 from inner body 250, fuel/air mixture 284 from outer premixer body 210 and any other fuel supply to combustion chamber 172.

In one example, a cracking process that results in greater than 30% conversion of ammonia 270 to hydrogen (H₂) and nitrogen (N₂) is sufficient to ensure 100% combustion with fuel 114A in fuel/air mixture 284 from outer premixer body 210 being methane (natural gas). Hence, hydrogen-containing flow 282 exiting inner body 250 is likely to contain less than 100% hydrogen (that is, it also likely includes ammonia in gaseous form and nitrogen). In any event, hydrogen from inner body 250 is sufficient to act as a pilot for combustor reaction zone 201 and will stabilize combustion in primary combustion zone 202. More particularly, hydrogen from inner body 250 reduces or eliminates any exhaustion of combustion in primary combustion zone 202 typically experienced with just ammonia injection. It will be recognized that the amount of hydrogen can be varied to address different situations depending on but not limited to factors such as: attributes of ammonia 270 (e.g., pressure, volume, flow rate, etc.); attributes of fuel 114A in fuel/air mixture 284 (e.g., type, pressure, volume, flow rate, flammability, heat production, etc.); attributes of combustion liner 164 among other attributes of combustor 100; attributes of air 112A-C; and/or AFS injector 150 parameters.

Exit 266 of ammonia passage 254 can be in a variety of different locations depending on the flow and/or dispersion characteristics desired. In FIG. 3, exit 266 is upstream of an end 256 of second inner tube 244, which is upstream of an end 258 of first outer tube 242 that is adjacent combustion chamber 172. In FIGS. 4 and 5, exit 266 is aligned with end 256 of second inner tube 244 and is axially upstream of discharge end 222 of burner 200, i.e., of outer premixer body 210. Second tube 244 can have any now known or later developed end 256 formation, e.g., constant inner diameter (FIG. 3) or narrowing inner diameter (FIG. 4), to create the desired flow and/or dispersion of hydrogen and ammonia from inner body 250 into primary combustion zone 202.

Burner 200 may also include end plate 257 coupled to inner hydrogen-generating body 250, e.g., hollow body 251. End plate 257 is configured to removably position inner hydrogen-generating body 250 within outer fuel/air premixer body 210. For example, outer fuel/air premixer body 210 may include an end member 286 that is coupled to an end cover 196 of combustor 100 to mount burner 200 in head end assembly 176 (FIG. 2). End plate 257 may be coupled to inner body 250, which may be coupled, in turn, to end member 286 that is coupled to end cover 196 of head end assembly 176 (FIG. 2), among possibly other structure. More particularly, end plate 257 may be coupled to at least hollow body 251. End plate 257 may include any necessary passages or openings for an upstream end of ammonia passage 254 to pass therethrough, i.e., upstream of heat exchanger portion 262. End plate 257 may also include any necessary passages or openings to provide second air inlet 252 and allow air 112C to enter hollow body 251 when second air inlet 252 is provided in end plate 257.

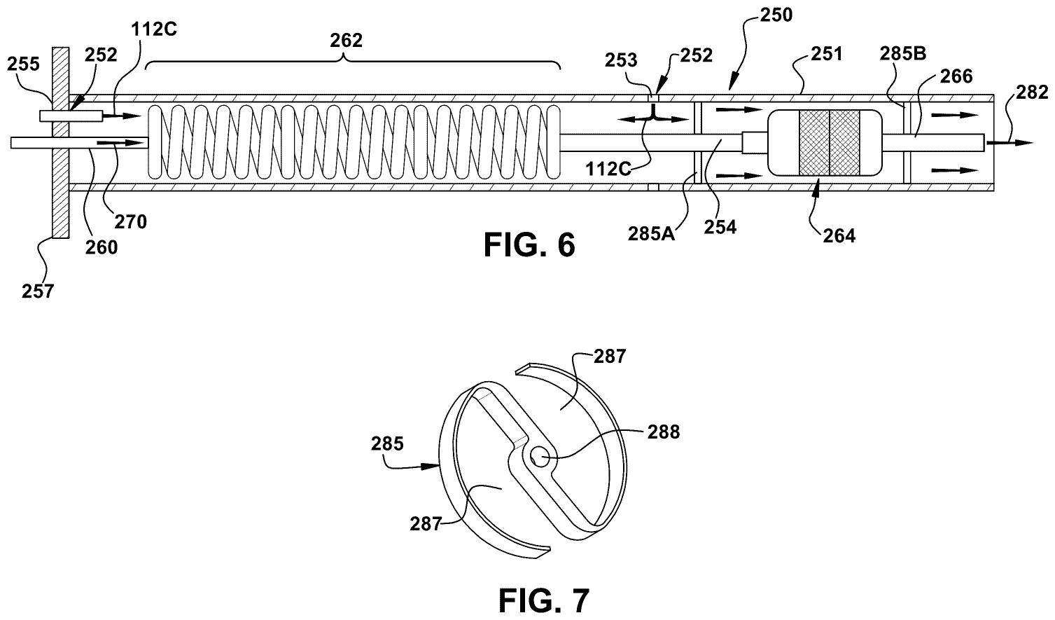

End plate 257 is configured to be removably positioned (with inner body 250) in end member 286, which mounts outer premixer body 210 in end cover 196 of head end assembly 176 of combustor 100. Each part can be fastened together in any manner, e.g., threaded fasteners (not shown). In this manner, removal of burner 200 can be attained by removing end member 286 from end cover 196 from connection to head end assembly 176, and slidingly removing burner 200. End member 286 can be selectively coupled to end cover 196 in head end assembly 176 in any now known or later developed manner, such as but not limited to threaded fasteners (not shown). In addition, removal of inner body 250 from the rest of burner 200, as shown in FIG. 6, can be attained by removing end plate 257 from end member 286, and slidingly removing inner body 250. Because the lifespan of catalyst portion 264 is typically shorter than the rest of burner 200, catalyst portion 264 is replaceable. That is, when either inner body 250 or burner 200 is removed from combustor 100, catalyst portion 264 can be selectively removed from inner body 250 and replaced with a new version thereof, when necessary. Catalyst portion 264 can be removably mounted in inner body 250 in any now known or later developed fashion, e.g., by threaded connection to part(s) of ammonia passage 254.

FIG. 7 shows a perspective view of a passage support 285 for ammonia passage 254 of inner hydrogen-generating body 250 for burner 200, according to embodiments of the disclosure. Any number of passage supports 285 may be used to position ammonia passage 254 in hollow body 251. Each passage support 285 can include any structure for holding a position of ammonia passage 254, e.g., a tube or another portion thereof, in hollow body 251, and an open interior 287 to allow air 112C to pass therethrough. The example shown in FIG. 7 is just one possible structure capable of this function. In the example shown, passage support 285 holds ammonia passage 254 centered in hollow body 251 (e.g., in centrally located aperture 288), but this is not necessary in all cases, e.g., it may be advantageous to position ammonia passage 254 closer to hollow body 251 to absorb more heat therefrom. Any number of passage supports 285 can be used. As shown in FIGS. 6 and 7, a first passage support 285A may be positioned upstream of catalyst portion 264 to position ammonia passage 254 within hollow body 251, e.g., between catalyst portion 264 and heat exchanger portion 262. In addition, a second passage support 285B may be positioned downstream of catalyst portion 264 to position ammonia passage 254 within hollow body 251, e.g., between catalyst portion 264 and combustion reaction zone 201 and/or end 256 of second inner tube 244 (FIG. 4).

In certain embodiments, burner 200 may include a bellows portion (not shown) between hollow body 251 of inner hydrogen-generating body 250 and outer fuel/air premixer body 210 to compensate for differential thermal expansions between hollow body 251 of inner body 250 and outer fuel/air premixer body 210.

A method according to embodiments of the disclosure will now be described. The method occurs in burner 200 for combustor 100 of GT system 90. The method may include mixing air 112A and fuel 114A (into fuel/air mixture 284) for injection into combustor reaction zone 201 of combustor 100 in outer fuel/air premixer body 210 having first air inlet 212, fuel inlet 214 and mixing passage 216. After exiting mixing passage 216, fuel/air mixture 284 enters combustion chamber 172 for combustion in primary combustion zone 202. The method also includes generating hydrogen for injection into combustor reaction zone 201 in inner hydrogen-generating body 250 inside mixing passage 216 of outer fuel/air premixer body 210. As described herein, the hydrogen generating includes heating a gaseous ammonia 270 in ammonia passage 254 in hydrogen-generating body 250 to create hydrogen-containing flow 282. More particularly, the heating includes directing air 112C flow from second air inlet 252 in hollow body 251 over heat exchanger portion 262 and catalyst portion 264 to generate the hydrogen from a gaseous ammonia 270 flow therein. Air 112C conveys heat to heat exchanger portion 262 and catalyst portion 264 as air 112C flows thereover and within hollow body 251. Air 112C entering second air inlet 252 has a higher temperature than ammonia 270 flow in heat exchanger portion 262. The heat conveyed to ammonia 270 generates hydrogen-containing flow 282 from ammonia 270 flowing in ammonia passage 254.

More particularly, the additional heat may cause ammonia 270 to reach temperatures in a range of, for example, 287-593° C. (550-1100° F.). The added heat increases the performance of catalyst region 264 to crack at least part of ammonia 270 into constituent elements hydrogen (H₂) and nitrogen (N₂). The method also includes injecting hydrogen-containing flow 282 into combustion reaction zone 201 for combustion with at least fuel/air mixture 284 from outer premixer body 210. More particularly, the resulting hydrogen-containing flow 282 (including any uncracked ammonia) exits from exit 266 of ammonia passage 254 and passes to combustion chamber 172 for combustion in primary combustion zone 202 with at least fuel/air mixture 284 from outer premixer body 210. The method may also include removing inner body 250 and replacing catalyst portion 264.

Burner 200 including outer premixer body 210 and inner body 250 may be made of any now known or later developed combustion tolerant and oxidation resistant materials. The material may be metal and can be a pure metal or an alloy. Burner 200 including outer premixer body 210 and inner body 250 may include a metal that is typically used in a turbine component such as a turbine blade or nozzle and that has a higher temperature and higher oxidation tolerance than the materials typically used for combustion hardware. In this case, the material may include a non-reactive metal, e.g., made from a non-explosive or non-conductive powder, such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), a nickel-chromium-cobalt-molybdenum alloy (NiCrCoMo) (e.g., Haynes 232 or Haynes 282 available from Haynes International, Inc.), or a nickel-chromium-cobalt-titanium alloy (Ni—Cr—Co—Ti) (e.g., GTD 262 developed by General Electric Company). Other possibilities include, for example, René 108, CM 247, Mar M 247, and any precipitation harden-able (PH) nickel alloy.

In certain embodiments, burner 200 and/or parts thereof, e.g., outer premixer body 210, swozzle assembly 234, inner body 250, etc., may be additively manufactured using any now known or later developed technique capable of forming an integral body. Consequently, the different parts may include a plurality of parallel, sintered metal layers.

As shown in FIG. 2, embodiments of the disclosure may also include combustor 100 for GT system 90. Combustor 100 includes combustor body 160 including combustion liner 164. Combustor 100 also includes head end assembly 176 including a plurality of burners 200 directed into combustion liner 164. Burners 200 can be arranged in any desired manner such as, but not limited to, a circular pattern. Each burner 200 may be as described herein and is directed into combustion liner 164. Combustor 100 generally terminates at a point that is adjacent to a first stage 290 of stationary nozzles 292 of turbine 128. First stage 290 of stationary nozzles 292 at least partially defines turbine inlet 142 to turbine 128. Combustor body 160, i.e., combustion liner 164, at least partially defines a hot gas path (HGP) for routing combustion gases 122 from combustion chamber 172, i.e., primary combustion zone 202 and any secondary combustion zone 204, to turbine inlet 142 of turbine 128 during operation of GT system 90.

Embodiments of disclosure may also include, as shown in FIG. 1, GT system 90 including compressor section 110, combustion section 120 operatively coupled to compressor section 110, and turbine section 130 operatively coupled to combustion section 120. As described herein, combustion section 120 includes at least one combustor 100 including combustor body 160 including combustion liner 164, and head end fuel nozzle assembly 176 at a forward end of combustor body 160. Head end assembly 176 includes a plurality of burners 200 directed into combustion liner 164, as described herein.

The disclosure provides various technical and commercial advantages, examples of which are discussed herein. Embodiments of the disclosure provide an efficient way of burning ammonia without combustion exhaustion/blowout across operating conditions, with a small portion of ammonia cracked for stable combustion. The hydrogen-generating body presents an efficient way of using ammonia cracking to provide hydrogen (H₂) for combustion with ammonia. The hydrogen-generating body may provide complete conversion of ammonia (NH₃) to hydrogen (H₂) and nitrogen (N₂), or partial conversation of ammonia to hydrogen (H₂) and nitrogen (N₂) and ammonia (NH₃). In any event, the hydrogen-generating body generates the minimum requirement of a hydrogen-containing flow such that it is between 0.5% to 1% of total fuel flow. The resulting hydrogen-containing flow with air is injected in a center of each burner, i.e., like a pilot fuel injection. Hence, the hydrogen-containing flow may be injected at any aerodynamic stabilization locations to enhance the overall stabilization of the gas turbine combustion, e.g., with the fuel/air mixture from the outer fuel/air premixer body.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. A burner for a combustor of a gas turbine system, the burner comprising:
an outer fuel/air premixer body having a first air inlet, a fuel inlet, and a mixing passage, the outer fuel/air premixer body mixing fuel and air for injection into a combustion chamber; and
an inner hydrogen-generating body within the outer fuel/air premixer body, the inner hydrogen-generating body including:
a hollow body having a second air inlet; and
an ammonia passage within the hollow body, the ammonia passage having an ammonia inlet, a heat exchanger portion downstream from the ammonia inlet, a catalyst portion downstream of the heat exchanger portion, and an exit to the combustor reaction zone downstream of the catalyst portion,
wherein an air flow from the second air inlet in the hollow body heats the heat exchanger portion and the catalyst portion to generate a hydrogen-containing flow from an ammonia flow therein, the hydrogen-containing flow exiting from the exit of the ammonia passage to the combustion chamber.

2. The burner of claim 1, wherein the heat exchanger portion includes one of a helical passage and a sinusoidal passage.

3. The burner of claim 1, wherein the first air inlet and the second air inlet are in fluid communication with a discharge of a compressor upstream of the burner, wherein air entering the second air inlet has a higher temperature than the ammonia flow in the heat exchanger portion.

4. The burner of claim 1, wherein the ammonia flow is gaseous ammonia.

5. The burner of claim 1, wherein the outer fuel/air premixer body includes a first tube concentrically spaced from a second tube, and a swozzle assembly between the first tube and the second tube downstream of the first air inlet, the swozzle assembly including a plurality of turning vanes imparting a swirl to air passing therebetween, wherein each of the turning vanes includes an internal fuel flow passage in fluid communication with at least one fuel nozzle, the fuel inlet introducing fuel into the internal fuel flow passage.

6. The burner of claim 1, further comprising an end plate coupled to the inner hydrogen-generating body, the end plate configured to removably position the inner hydrogen-generating body within the outer fuel/air premixer body.

7. The burner of claim 6, wherein the second air inlet includes an opening in the end plate in fluid communication with a source of hot air.

8. The burner of claim 1, wherein the second air inlet includes an opening in the hollow body in fluid communication with the mixing passage.

9. The burner of claim 1, wherein the catalyst portion is replaceable.

10. The burner of claim 1, further comprising a first passage support positioned upstream of the catalyst portion to position the ammonia passage within the hollow body, and a second passage support positioned downstream of the catalyst portion to position the ammonia passage within the hollow body, wherein each passage support includes an open interior to allow air to pass therethrough.

11. A combustor for a gas turbine system, the combustor comprising:
a combustor body including a combustion liner;
a head end assembly including a plurality of burners directed into the combustion liner, at least one burner including:
an outer fuel/air premixer body having a first air inlet, a fuel inlet, and a mixing passage, the outer fuel/air premixer body mixing fuel and air for injection into a combustion chamber; and
an inner hydrogen-generating body within the outer fuel/air premixer body, the inner hydrogen-generating body including:
a hollow body having a second air inlet; and
an ammonia passage within the hollow body, the ammonia passage having an ammonia inlet, a heat exchanger portion downstream from the ammonia inlet, a catalyst portion downstream of the heat exchanger portion, and an exit to the combustor reaction zone downstream of the catalyst portion,
wherein an air flow from the second air inlet in the hollow body heats the heat exchanger portion and the catalyst portion to generate a hydrogen-containing flow from an ammonia flow therein, the hydrogen-containing flow exiting from the exit of the ammonia passage to the combustion chamber.

12. The combustor of claim 11, wherein the heat exchanger portion includes one of a helical passage and a sinusoidal passage.

13. The combustor of claim 11, wherein the first air inlet and the second air inlet are in fluid communication with a discharge of a compressor upstream of the burner, wherein air entering the second air inlet has a higher temperature than the ammonia flow in the heat exchanger portion.

14. The combustor of claim 11, wherein the outer fuel/air premixer body includes a first tube concentrically spaced from a second tube, and a swozzle assembly between the first tube and the second tube downstream of the first air inlet, the swozzle assembly including a plurality of turning vanes imparting a swirl to air passing therebetween, wherein each of the turning vanes includes an internal fuel flow passage in fluid communication with at least one fuel nozzle, the fuel inlet introducing fuel into the internal fuel flow passage.

15. The combustor of claim 11, further comprising an end plate coupled to the inner hydrogen-generating body, the end plate configured to removably position the inner hydrogen-generating body within the outer fuel/air premixer body.

16. The combustor of claim 15, wherein the second air inlet includes an opening in the end plate in fluid communication with a source of hot air.

17. The combustor of claim 11, wherein the second air inlet includes an opening in the hollow body in fluid communication with the mixing passage.

18. The combustor of claim 11, further comprising a first passage support positioned upstream of the catalyst portion to position the ammonia passage within the hollow body, and a second passage support positioned downstream of the catalyst portion to position the ammonia passage within the hollow body, wherein each passage support includes an open interior to allow air to pass therethrough.

19. A method comprising:
in a burner for a combustor of a gas turbine system:
mixing air and fuel for injection into a combustion chamber of the combustor in an outer fuel/air premixer body having a first air inlet, a fuel inlet, and a mixing passage; and
generating hydrogen for injection into the combustor reaction zone in an inner hydrogen-generating body inside the mixing passage of the outer fuel/air premixer body, the hydrogen generating including heating a gaseous ammonia in an ammonia passage in the hydrogen-generating body to form a hydrogen-containing flow; and
injecting the hydrogen-containing flow into the combustion chamber for combustion with a fuel/air mixture from the outer fuel/air premixer body.

20. The method of claim 19, wherein an inner hydrogen-generating body includes:
a hollow body having a second air inlet; and
wherein the ammonia passage is within the hollow body and includes an ammonia inlet, a heat exchanger portion downstream from the ammonia inlet, a catalyst portion downstream of the heat exchanger portion, and an exit to the combustion zone downstream of the catalyst portion,
wherein the heating includes directing an air flow from the second air inlet in the hollow body over the heat exchanger portion and the catalyst portion to generate the hydrogen from a gaseous ammonia flow therein, the hydrogen-containing flow exiting from the exit of the ammonia passage for the injecting into the combustion chamber.
